(19) United States
(12) Patent Application Publication
(10) Pub. No.: US 2016/0234406 A1
(43) Pub. Date: Aug. 11, 2016

(54) CAMERA ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JUN WANG, Wuhan (CN); DA-LONG SUN, Wuhan (CN); CHUNG CHAI, New Taipei (TW)

(21) Appl. No.: 14/666,538

(22) Filed: Mar. 24, 2015

(30) Foreign Application Priority Data
Feb. 9, 2015 (CN) 201510065892.8

(51) Int. Cl. H04N 5/225

(52) U.S. Cl. CPC H04N 5/2251

(57) ABSTRACT

A camera assembly includes an operation tab, a transmission member, baffle plate, and a camera. The operation tab and the baffle plate are engaged with the transmission member. The operation tab is configured to move along an operating direction and drive the baffle plate to move through the transmission member. The baffle plate is configured to move to cover the camera. A moving direction of the baffle plate is substantially perpendicular to the operating direction.

### CROSS-REFERENCE TO RELATED APPLICATIONS

This application claims priority to Chinese Patent Application No. 201510065892.8 filed on Feb. 9, 2015, the contents of which are incorporated by reference herein.

### FIELD

The subject matter herein generally relates to a camera assembly.

### BACKGROUND

A computer usually includes a camera. A user can use the camera to share videos with others. However, the camera can be illegally controlled through a network by others.

### BRIEF DESCRIPTION OF THE DRAWINGS

Implementations of the present technology will now be described, by way of example only, with reference to the attached figures.

FIG. 1 is an exploded, isometric view of one embodiment of a camera assembly.

FIG. 2 is similar to FIG. 1, but viewed from another angle.

FIG. 3 is an isometric view of a transmission member for the connector assembly of FIG. 1.

FIG. 4 is an assembled, isometric view of the camera assembly of FIG. 1.

FIG. 5 is an isometric view of the internal structure of camera assembly of FIG. 4.

FIG. 6 is similar to FIG. 4, but shown in a working state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a camera assembly

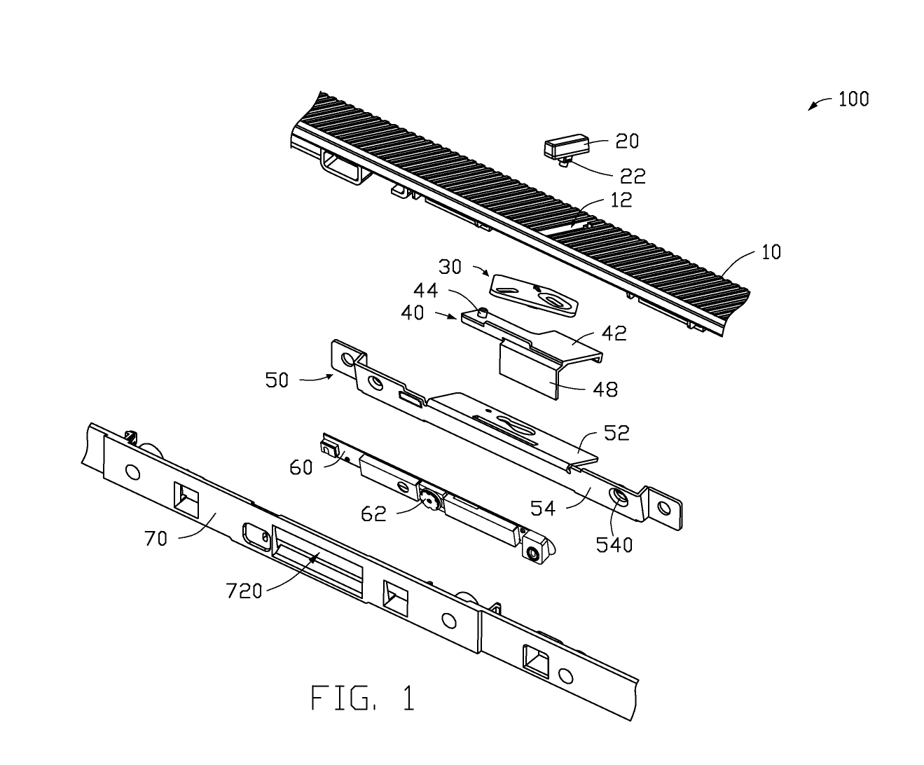

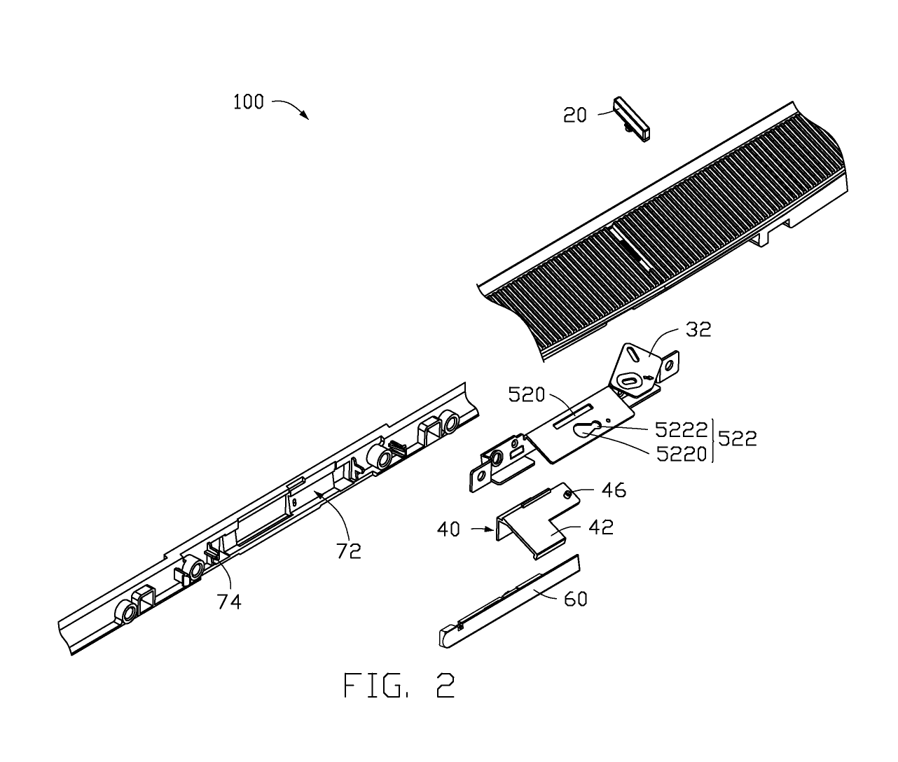

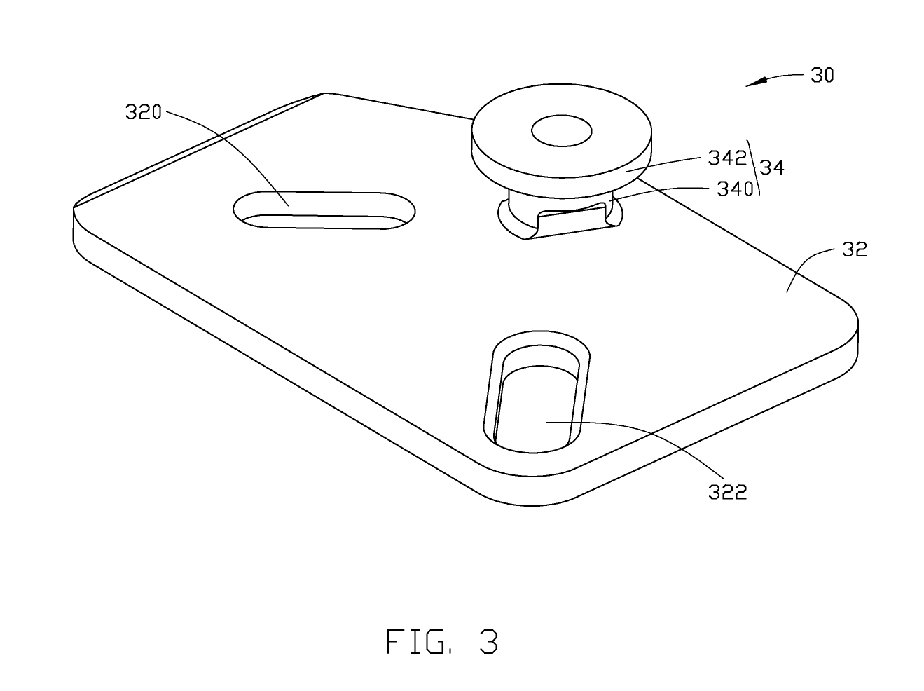

FIGS. 1-3 illustrate one embodiment of a camera assembly 100. The camera assembly 100 includes a cover 10, an operation tab 20, a transmission member 30, a baffle plate 40, a fixing member 50, a camera member 60, and a panel 70.

The cover 10 defines a mounting groove 12. The operation tab 20 includes a first transmission post 22. The transmission member 30 includes a transmission plate 32 and a connecting post 34. The connecting post 34 extends from the transmission plate 32. The transmission plate 32 defines a first groove 320 and a second groove 322, both the first groove 320 and the second groove 322 can extend along a straight line. Two straight lines form an acute angle. The connecting post 34 includes a latching portion 340 and a stopper portion 342. The latching portion 340 extends from the transmission plate 32. The stopper portion 342 extends from the latching portion 340. A cross section of the stopper portion 342 is greater than a cross section of the latching portion 340. The baffle plate 40 includes a sliding plate 42, a second transmission post 44, a protrusion 46, and a shielding tab 48. The shielding tab 48 extends from the sliding plate 42 and is substantially perpendicular to the sliding plate 42. The second transmission post 44 and the protrusion 46 extend from the two sides of the sliding plate 42 and are located on the one end of the sliding plate 42. The fixing member 50 includes a mounting plate 52 and a fixing plate 54. The fixing plate 54 extends from the mounting plate 52. A guiding groove 520 and a connecting hole 522 are defined in the mounting plate 52. A first hole 5220 and a second hole 5222 are defined in the connecting hole 522. The first hole 5220 communicates with the second hole 5222. Two fixing holes 540 are defined in the fixing plate 54. The camera member 60 includes a camera 62. The panel 70 defines a receiving space 72. An opening 720 is defined in the receiving space 72. The panel 70 further includes two fixing posts 74. The two fixing posts 74 are located on the two sides of the opening 720.

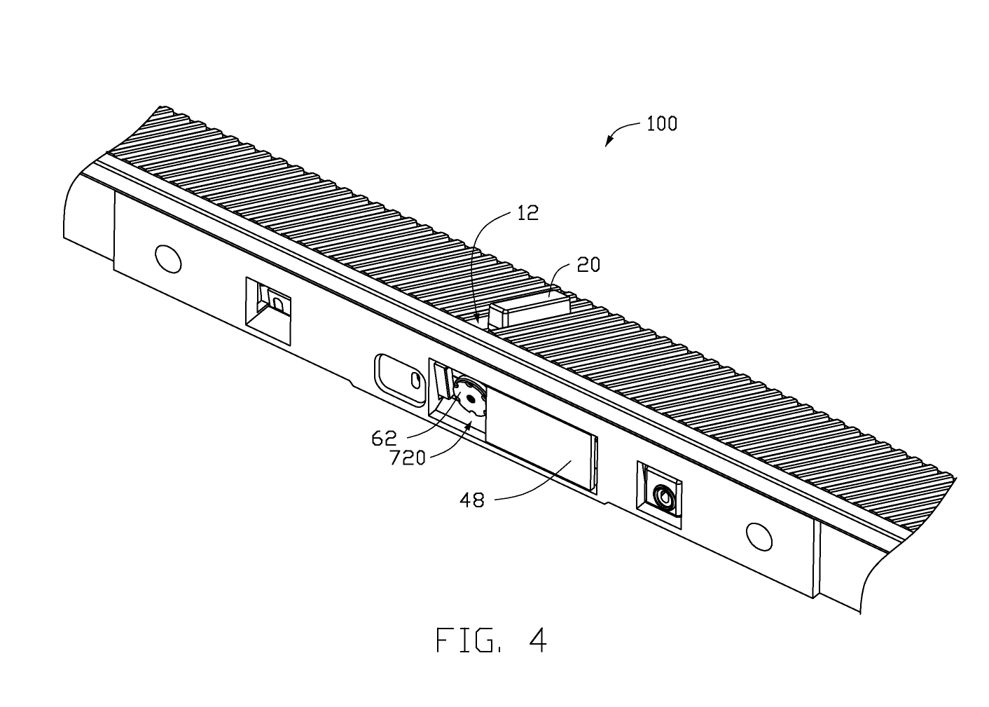

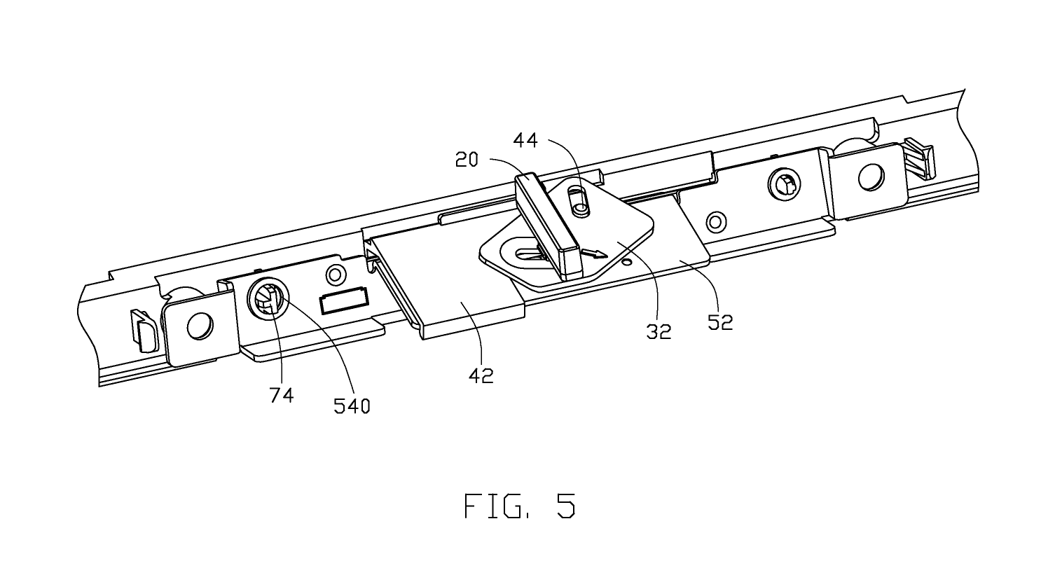

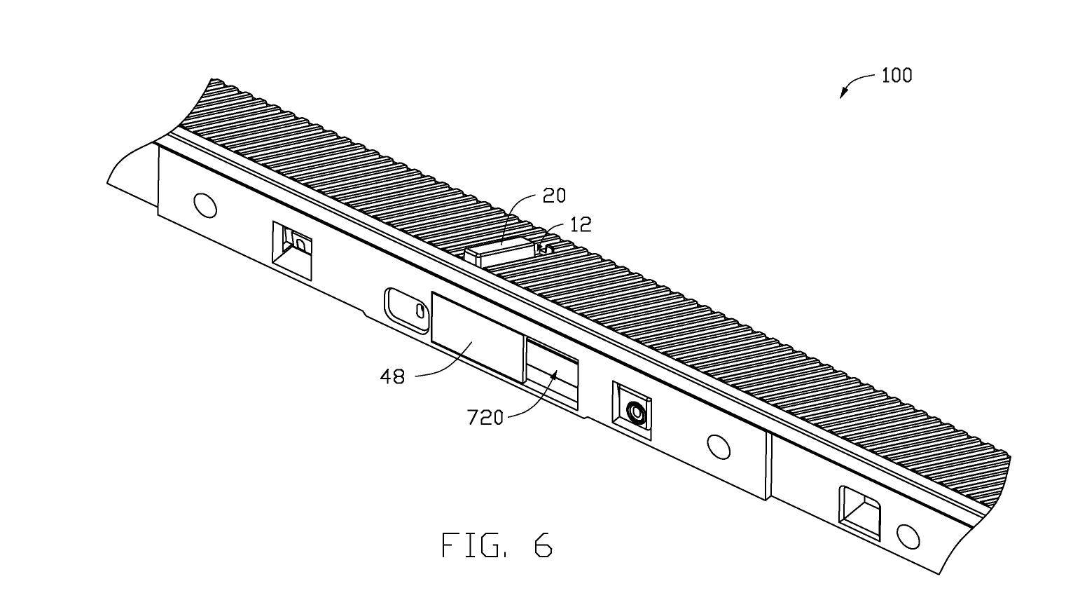

FIGS. 4-6 illustrate assembled views of the camera assembly of FIG. 1. When the camera assembly 100 is assembled, the camera member 60 is received in the receiving space 72.

The camera 62 aligns with the opening 720. The two fixing posts 74 are engaged with the two fixing holes 540 to fix the fixing member 50 with the panel 70. The camera member 60 is located between the fixing member 50 and the panel 70. The mounting plate 52 is sheathed with the sliding plate 42. The protrusion 46 extends into the guiding groove 520. The shielding tab 48 is received in the opening 720. The connecting post 34 moves from the first hole 5220 to the second hole 5222. The latching portion 340 is engaged with the second hole 5222. The second transmission post 44 extends into the second groove 322. The cover 10 is fixed with the panel 70. The first transmission post 22 passes through the mounting groove 12 and extends into the first groove 320. The operation tab 20 is mounted on the cover 10. The shielding tab 48 is covering one side of the camera 62.

When the camera assembly 100 is in use, the operation tab 20 moves along an operating direction within the mounting groove 12. The first transmission post 22 moves within the first groove 320 pushing the transmission member 30 to rotate about the connecting post 34. The transmission member 30 then drives the second transmission post 44 to move. The shielding tab 48 is moved within the opening 720. A moving direction of the shielding tab 48 is substantially perpendicular to the operating direction. The shielding tab 48 can cover the camera 62.

The embodiments shown and described above are only examples. Many details are often found in the art such as the other features of a camera assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A camera assembly comprising:
an operation tab;
a transmission member;
a baffle plate; and
a camera;
wherein the operation tab and the baffle plate are engaged with the transmission member, the operation tab is configured to move along an operating direction and drive the baffle plate to move via the transmission member, the baffle plate is configured to move to cover the camera, a moving direction of the baffle plate is substantially perpendicular to the operating direction.

2. The camera assembly of claim 1, further comprising a fixing member, wherein the transmission member is configured to rotate relative to the fixing member.

3. The camera assembly of claim 2, wherein the transmission member defines a first groove, the operation tab comprises a first transmission post, the first transmission post extends into the first groove and moves within the first groove.

4. The camera assembly of claim 3, wherein the first groove extends along a straight line.

5. The camera assembly of claim 2, wherein the transmission member defines a second groove, the baffle plate comprises a second transmission post, and the second transmission post is received in the second groove.

6. The camera assembly of claim 5, wherein the second groove extends along a straight line.

7. The camera assembly of claim 5, wherein the fixing member defines a guiding groove, the baffle plate further comprises a protrusion, the protrusion extends into the guiding groove and moves within the guiding groove.

8. The camera assembly of claim 7, wherein the baffle plate further comprises a sliding plate, and the second transmission post and the protrusion extend from the two sides of the sliding plate.

9. The camera assembly of claim 8, further comprising a panel, wherein the panel defines an opening, the camera is engaged with the panel and aligns with the opening, the baffle plate further comprises a shielding tab, the shielding tab is substantially perpendicular to the sliding plate, and the shielding tab is received in the opening and is configured to move within the opening.

10. The camera assembly of claim 2, wherein the fixing member defines a connecting hole, the transmission member comprises a connecting post, and the connecting post is engaged with the connecting hole.

11. A camera assembly comprising:
an operation tab;
a transmission member; and
a baffle plate;
wherein the operation tab and the baffle plate are engaged with the transmission member, the operation tab is configured to move along an operating direction and drive the baffle plate to move via the transmission member, the baffle plate is configured to move to cover a camera, a moving direction of the baffle plate is substantially perpendicular to the operating direction.

12. The camera assembly of claim 11, further comprising a fixing member, wherein the transmission member is configured to rotate relative to the fixing member.

13. The camera assembly of claim 12, wherein the transmission member defines a first groove, the operation tab comprises a first transmission post, the first transmission post extends into the first groove and moves within the first groove.

14. The camera assembly of claim 13, wherein the first groove extends along a straight line.

15. The camera assembly of claim 12, wherein the transmission member defines a second groove, the baffle plate comprises a second transmission post, and the second transmission post is received in the second groove.

16. The camera assembly of claim 15, wherein the second groove extends along a straight line.

17. The camera assembly of claim 15, wherein the fixing member defines a guiding groove, the baffle plate further comprises a protrusion, the protrusion extends into the guiding groove and moves within the guiding groove.

18. The camera assembly of claim 17, wherein the baffle plate further comprises a sliding plate, and the second transmission post and the protrusion extend from the two sides of the sliding plate.

19. The camera assembly of claim 18, further comprising a panel, wherein the panel defines an opening, the camera is engaged with the panel and aligns with the opening, the baffle plate further comprises a shielding tab, the shielding tab is substantially perpendicular to the sliding plate, and the shielding tab is received in the opening and is configured to move within the opening.

20. The camera assembly of claim 12, wherein the fixing member defines a connecting hole, the transmission member comprises a connecting post, and the connecting post is engaged with the connecting hole.
